(19) United States
(12) Patent Application Publication
(10) Pub. No.: US 2025/0229787 A1
(43) Pub. Date: Jul. 17, 2025

(54) ROADWAY CONDITION MONITORING BY DETECTION OF ANOMALIES

(71) Applicant: CEPTION TECHNOLOGIES LTD., Jerusalem (IL)

(72) Inventors: Yossef Israel BUDA, Kfar-Adumim (IL); Tal ISRAEL, Mazkeret-Batya (IL)

(73) Assignee: CEPTION TECHNOLOGIES LTD., Jerusalem (IL)

(21) Appl. No.: 19/172,211

(22) Filed: Apr. 7, 2025

Related U.S. Application Data
(63) Continuation of application No. 18/017,853, filed on Jan. 24, 2023.
(60) Provisional application No. 63/057,358, filed on Jul. 28, 2020.

(51) Int. Cl. B60W 40/06; G08G 1/01; G08G 1/052; G08G 1/056; G08G 1/16

(52) U.S. Cl. CPC B60W 40/06; G08G 1/0112; G08G 1/0141; G08G 1/052; G08G 1/056; G08G 1/166; B60W 2556/40

(57) ABSTRACT

A roadway condition monitoring system is configured to receive sensed data that is acquired by sensors that are mounted on vehicles that operate on a roadway. The sensed data includes values of parameters that characterize a roadway condition, including a pattern of travel of the vehicles along the roadway or a mapping of the roadway. A current roadway condition is calculated from the sensed data that is received during a current trip of the vehicles on a segment of the roadway, and the current roadway condition is compared with a nominal roadway condition. The calculation of the nominal roadway condition utilizes the sensed data that is received from the sensors during a plurality of trips of the vehicles on the segment. When an anomaly is detected in which the current roadway condition deviates from the nominal roadway condition, a notification of the detected anomaly is issued.

### CROSS-REFERENCE TO RELATED APPLICATIONS

This application is a Continuation of U.S. patent application Ser. No. 18/017,853, filed Jan. 24, 2024, which is a US National Phase Patent Application of PCT International Patent Application No. PCT/IL2021/050908, International Filing Date Jul. 28, 2021, claiming the benefit of U.S. Provisional Patent Application No. 63/057,358, filed Jul. 28, 2020, which is hereby incorporated by reference.

### FIELD OF THE INVENTION

The present invention relates to road maintenance. More particularly, the present invention relates to monitoring of the condition of a roadway by detection of anomalies in vehicle traffic on the roadway or detecting anomalies in mapping of the roadway.

### BACKGROUND OF THE INVENTION

The process of loading and dumping materials in mining and construction sites typically includes transportation of payloads along various types or roadways. The roadways may include temporary or unpaved roads, or standard roads. Roadways may become damaged due to traffic of heavy vehicles or vehicles carrying heavy payloads. Boulders, transported materials, or other debris may fall onto the roadway, or the surface of the roadway may develop cracks or potholes due to traffic on the roadway, weather or other environmental conditions, or other causes.

Poor conditions on the roadway, in addition to presenting a safety hazard, may delay traffic of the vehicle at the site, and thus may delay operations at the site. In addition, such roadway conditions may result in increased fuel consumption and increased vehicle wear and tear. The resulting increase in cost of operation of the site may be significant.

Some roadway defects may present serious safety hazards. For example, a ground fracture may indicate unstable or collapsing ground conditions. A missing or defective berms or safety barriers that does not meet safety standards could result in accidents with serious risk to life and limb and risk of damage or loss of vehicles or equipment.

### SUMMARY OF THE INVENTION

There is thus provided, in accordance with an embodiment of the invention, a roadway condition monitoring system including a processor that is configured to: receive sensed data that is acquired by one or more sensors that are mounted on one or more vehicles that operate on a roadway, the sensed data including at least a value of each of one or more parameters that characterize a roadway condition that includes one or both of a pattern of travel of the one or more vehicles along the roadway and a mapping of the roadway; calculate a current roadway condition from the sensed data that is received during a current trip of the one or more vehicles on a segment of the roadway; compare the current roadway condition with a nominal roadway condition that characterizes one or both of traffic of the one or more vehicles in the segment of the roadway and mapping of the segment, the calculation of the nominal roadway condition utilizing the sensed data that is received from the one or more sensors during a plurality of trips of the one or more vehicles on the segment; and when an anomaly is detected in which the current roadway condition deviates from the nominal roadway condition, issue a notification of the detected anomaly.

Furthermore, in accordance with an embodiment of the invention, the processor is further configured to calculate the nominal roadway condition.

Furthermore, in accordance with an embodiment of the invention, the sensed value of a parameter of the one or more parameters is selected from a group of parameters consisting of: a speed of travel, a direction of travel, a steering angle, an acceleration, a deceleration, a location of the vehicle and a distance travelled.

Furthermore, in accordance with an embodiment of the invention, a sensor of the one or more sensors is selected from a group of sensors consisting of: a speedometer, an inertial measurement unit (IMU), a global navigation satellite system (GNSS) receiver, an odometer and a steering angle sensor.

Furthermore, in accordance with an embodiment of the invention, the one or more sensors include a mapping sensor.

Furthermore, in accordance with an embodiment of the invention, the mapping sensor includes a sensor selected from a group of sensors consisting of: an imaging device, lidar and radar.

Furthermore, in accordance with an embodiment of the invention, the processor is configured to generate a map of the roadway by applying a three-dimensional reconstruction technique to data received from the mapping sensor and from at least one other sensor of the one or more sensors.

Furthermore, in accordance with an embodiment of the invention, the three-dimensional reconstruction technique includes a visual simultaneous localization and mapping (VSLAM) technique or a structure from motion (SFM) technique.

Furthermore, in accordance with an embodiment of the invention, the map is a three-dimensional map.

Furthermore, in accordance with an embodiment of the invention, the processor is further configured to identify an obstacle on the roadway.

Furthermore, in accordance with an embodiment of the invention, the processor is further configured to transmit an image of the identified obstacle.

Furthermore, in accordance with an embodiment of the invention, the processor is configured determine a location of the identified obstacle relative to the mapping of the roadway.

Furthermore, in accordance with an embodiment of the invention, the processor is configured to send a notification of the location of the identified obstacle.

There is further provided, in accordance with an embodiment of the invention, a method for monitoring a condition of a roadway, the method including: receiving by a processor sensed data that is acquired by one or more sensors that are mounted one or more vehicles that operate on a roadway, the sensed data including at least a value of each of one or more parameters that characterize a roadway condition that includes one or both of a pattern of travel of the one or more vehicles along the roadway and a mapping of the roadway; comparing the current roadway condition with a nominal roadway condition that characterizes one or both of traffic of the one or more vehicles in the segment and mapping of the segment, the calculation of the nominal roadway condition utilizing the sensed data that is received from the one or more sensors during a plurality of trips of the one or more vehicles on the segment; and when an anomaly is detected in which the current roadway condition deviates from the nominal roadway condition, issuing a notification of the detected anomaly.

Furthermore, in accordance with an embodiment of the invention, the method includes generating a map of the roadway.

Furthermore, in accordance with an embodiment of the invention, generating the map includes applying a three-dimensional reconstruction technique to data received from a mapping sensor and from at least one other sensor of the one or more sensors.

Furthermore, in accordance with an embodiment of the invention, the three-dimensional reconstruction technique includes a VSLAM technique or an SFM technique.

Furthermore, in accordance with an embodiment of the invention, the method includes identifying an obstacle on the roadway.

Furthermore, in accordance with an embodiment of the invention, the method includes determining a location of the identified obstacle relative to the map.

### BRIEF DESCRIPTION OF THE DRAWINGS

In order for the present invention to be better understood and for its practical applications to be appreciated, the following Figures are provided and referenced hereafter. It should be noted that the Figures are given as examples only and in no way limit the scope of the invention. Like components are denoted by like reference numerals.

FIG. 1 schematically illustrates a roadway condition monitoring system, in accordance with an embodiment of the invention.

FIG. 2 is a schematic block diagram of an example of a vehicle unit of the roadway condition monitoring system illustrated in FIG. 1.

FIG. 3 is a schematic block diagram illustration of an example of operation of the roadway condition monitoring system illustrated in FIG. 1.

FIG. 4 is a flow chart depicting a method of operation of the roadway condition monitoring system illustrated in FIG. 1.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, the conjunction “or” as used herein is to be understood as inclusive (any or all of the stated options).

Some embodiments of the invention may include an article such as a computer or processor readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein.

In accordance with an embodiment of the invention, a roadway condition monitoring system is configured to monitor the condition of a roadway by detecting anomalies in traffic along that roadway, or by detecting anomalies in mapping of the roadway. As used herein, a roadway includes any type or permanent or temporary path or road along which vehicles of one or more types may travel. Often, a roadway at a mining or construction site may be unpaved and may be intended for traffic during a phase of mining or construction operations, and may be abandoned at a later phase. In some cases, and in particular where the roadway abuts excavations, pits, valleys, or other topographical depressions, sides of the roadway may be lined with safety berms, or other types of barriers. The barriers may serve to indicate or mark the sides of the roadway and to block or impede any vehicle that is straying off the roadway.

A plurality of vehicles that are configured to cooperate with the roadway condition monitoring system are each provided with a vehicle unit that is configured to communicate with the roadway condition monitoring system. As used herein, the term “vehicle unit” refers collectively to all devices that are mounted on a vehicle that operate in cooperation with the roadway condition monitoring system. Some or more of the components of a vehicle unit may have been present in the vehicle prior to installation of the vehicle unit in association with the roadway condition monitoring system. Devices that are installed in or on the vehicle in order to enable cooperation with the roadway condition monitoring system may be housed together in a single housing, or may be mounted at separate locations on the vehicle. In some cases, a component of the vehicle unit may include an article, such as a smartphone or similar device, that is associated with, or is located on the person of, an operator of the vehicle.

The vehicle unit includes one or more sensors that sense various parameters that characterize conditions along the roadway. For example, the sensors may be configured to sense one or more of a speed of travel (e.g., the speedometer of the vehicle, a Global Navigation Satellite System (GNSS) receiver, Doppler radar, or another sensor that is configured to measure a speed of the vehicle), a direction of travel (e.g., gyroscope, compass, GNSS, or other device), a steering angle (e.g., steering angle sensor), an acceleration or deceleration (e.g., an accelerometer, inertial measurement unit (IMU), or other device), a distance travelled (e.g., odometer or GNSS), a change in direction of travel (e.g., an IMU, or other device), a slope of travel (e.g., tilt sensor, IMU, or other device), or other sensor that may measure a parameter that characterizes travel of the vehicle over a monitored roadway.

In addition, the vehicle unit may include one or more sensors for imaging or otherwise detecting or mapping an environment of the vehicle. For example, one or more cameras or other imaging devices (e.g., operating in the visible, infrared, or other spectral range) may acquire video or single-frame images of the roadway or of other surfaces, objects, or vehicles that within viewing range of the imaging device. For example, a vehicle may include an imaging device that acquires images of a region in front of the vehicle, while another imaging device acquires images of a region behind the vehicle. One or more other rangefinder sensors, e.g., employing lidar, radar, ultrasound, or another type of wave, may detect a distance to a surface (e.g., a surface that is nearest to the vehicle). Where the rangefinder sensor is a scanning sensor, the sensor may produce a two- or three-dimensional map of nearby surfaces.

The vehicle unit includes one or more components that enable communication of the vehicle unit with a controller of the roadway condition monitoring system, or with other components of the roadway condition monitoring system. For example, parameters that are sensed by the sensors may be transmitted continually, or periodically, to the controller. In some cases, e.g., when an operator of the vehicle visually identifies an obstacle or hazard on the roadway, communication of information to the controller may be initiated by an operator of the vehicle. Communication of the vehicle unit with the controller may identify the vehicle on which that vehicle unit is mounted (e.g., by license tag number, by an identifier that is assigned by the roadway condition monitoring system, or other type of identifier). The communication may specify a type of the vehicle, or the controller may maintain a database that associates each vehicle identifier with a type of vehicle.

The controller of the roadway condition monitoring system is configured to receive the data that is transmitted by the vehicle units and analyze the data. The analysis may include mapping the various roadways at the site at which the roadway condition monitoring system operates. It may be noted that at many types of sites at which the roadway condition monitoring system operates, a roadway may be temporary and changing as operations at the site change. An actual roadway that is used by vehicles may be different from a roadway as planned.

In some cases, the controller may analyzed data from one or more imaging devices or three-dimensional mapping or rangefinder devices to identify various surfaces and hazards along or on the roadway. For example, the controller may identify walls, berms, cliffs, guardrails, or other structures or topographical features that abut the roadway and that serve to confine the width of the roadway on which vehicles may travel. The controller may identify various hazards on the roadway that may be elevated above the surface of the roadway (e.g., boulders, logs, beams, structures, mounds, stopped or abandoned vehicles, or other elevated hazards), or that are depressed below the surface of the roadway (e.g., pits, puddles sinkholes, cracks, or other depressed hazards). In some cases, the controller may identify an anomaly regarding an anomalous roadway surface by a difference in shading or coloration of the surface. The controller may identify defects in the surface of a safety berm, or berm dimensions (e.g., height or width) that do not meet safety standards.

The analysis of sensor data by the controller typically includes determining nominal roadway conditions along one or more roadways of a site at which the roadway condition monitoring system operates. The nominal conditions may include a nominal traffic pattern, a nominal mapping of the roadway, or both. For example, a nominal traffic pattern may be characterized by an expected speed and direction of travel of vehicles along each segment of the roadway. A nominal pattern may be characterized by expected dimensions of the roadway and of features on or near the roadway, surface properties of the roadway (e.g., flatness, slope, roughness, or other mapped properties), conditions of walls, barriers, or other structures that line or abut the roadway, presence of permanent obstacles (e.g., raised or depressed areas, objects, structures, or other permanent obstacles), or other characteristics of the roadway that are expected to remain unchanged for a minimal period of time.

For example, a nominal traffic pattern may be calculated by application of a filter to a set of momentary sensed traffic data. The filter may include calculating a moving average of traffic data, or other statistical techniques that may be applied to distinguish a relatively long-term traffic pattern from short-term variations. A nominal traffic pattern may be expected to change, e.g., as the nature of operations at the site changes over time.

A roadway may be divided into segments that are each characterized by a nominal traffic pattern that is associated with that segment. In some examples, an entire roadway (e.g., between intersections with other roadways or terminations of the roadway) may be treated as a single segment. In another example, the roadway may be divided into segments of equal length. In another example, the lengths of segments may depend on characteristics of the roadway, e.g., as determined by traffic data. For example, a portion of a roadway that is straight and along which vehicles tend to travel at constant speed may be divided into fewer or longer segments than a roadway that is curvy or where the speed of travel tends to vary rapidly (e.g., due to changes in the surface of the roadway, cross traffic, obstacles, in the number of vehicles that operate, or other changes).

In some cases, different nominal traffic patterns may be calculated for different types of vehicles. For example, expected speed may differ between a vehicle that is easily maneuverable and a vehicle that is less maneuverable, or between a vehicle that is sufficiently large, rugged, or equipped to be insensitive to some types of obstacles and a vehicle that must avoid those obstacles.

The controller is configured to continue to receive sensor data from the vehicles after a nominal roadway condition has been calculated. For example, sensors of a vehicle unit of a vehicle may continue to sense the speed and orientation of the vehicle, or continue to map the roadway, and to transmit the data to the controller. The controller may thus continually monitor traffic of the vehicles along one or more roadways, as well as mapped features of the roadways.

In some cases, the controller may indicate a deviation of a current monitored roadway condition from a nominal roadway condition.

For example, current monitored vehicle traffic may deviate from the calculated nominal traffic pattern. Monitoring the traffic may indicate that vehicles are travelling at a speed that deviates from the nominal traffic pattern (e.g., is slower) at a point along the roadway. As another example, monitoring the traffic may indicate that the direction of travel of vehicles deviates from the nominal traffic pattern at a point along the roadway. Such deviations from the nominal traffic pattern may be indicative of a need for corrective action. For example, the deviations may be indicative of formation of new obstacle on the roadway, damage to the roadway, or another problem.

In another example, current mapping of the roadway may deviate from a previously mapped nominal map of the roadway. The deviation may indicate a change in the structure of the roadway.

When a deviation from nominal roadway conditions is detected by the controller, the controller may transmit the location of the deviation to a relevant recipient of the information. For example, the location may be transmitted to a manager of the site, to a maintenance crew, to operators of vehicles that are on the roadway where the deviation was detected, or to another relevant recipient.

In some cases, the controller may be configured to identify a cause of the deviation. For example, the controller may be configured to analyze data from an imaging or mapping sensor to identify an obstacle or defect along the roadway that is the cause of the detected deviation. In some cases, identifying the obstacle or defect may result from a machine learning process, e.g., from analyzing sets of sensor data from independently identified obstacles or defects.

In some cases, the controller of a roadway condition monitoring system may cooperate with a vehicle guidance system (which may be incorporated into, or may operate independently of, the roadway condition monitoring system). For example, when a deviation from a nominal traffic pattern is detected, the roadway condition monitoring system may transmit the data, along with any information regarding the cause of the deviation, if available, to the vehicle guidance system. The vehicle guidance system may utilized the transmitted data to guide a vehicle along an alternative route that avoids the location of the deviation.

A roadway condition monitoring system, in which anomalies in a roadway are detected via sensors that are mounted on a vehicle that travels on a roadway, may be advantageous over other types of roadway condition monitoring systems.

For example, at a construction or mining site, the course of a roadway or conditions along a roadway may be changing at a rapid rate (e.g., as compared with roadways in a typical urban or rural setting). As such, as opposed to a typical situation in which a GNSS is utilized to monitor road or traffic conditions, the accuracy of a map that is generated and stored in a database of the system must be verified and modified at frequent intervals. Monitoring the road and traffic conditions by sensors that are mounted on the vehicles that travel on a roadway, and automatically noting deviations from a previously generated map or nominal traffic pattern, may enable the roadway condition monitoring system to maintain an updated map, and to notify relevant parties when a deviation is noted.

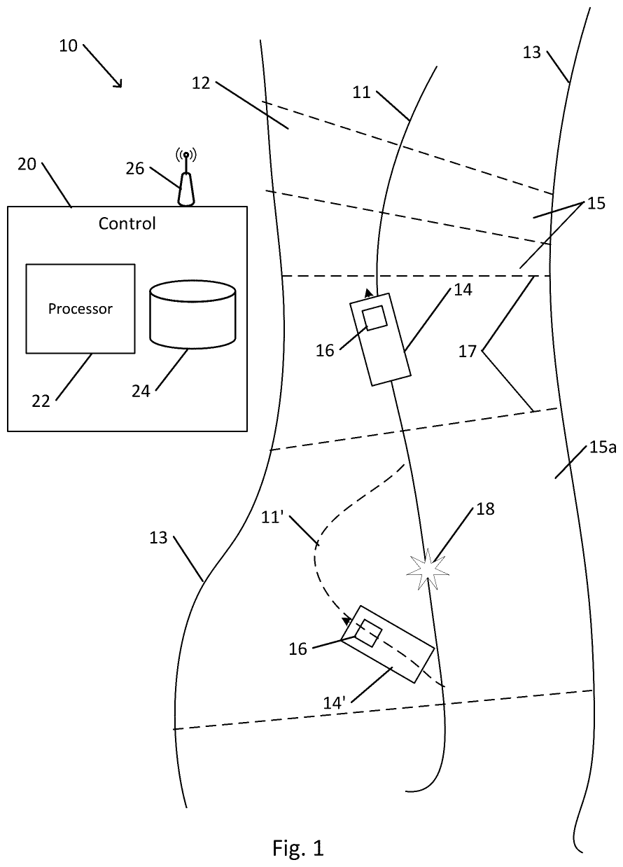

FIG. 1 schematically illustrates a roadway condition monitoring system, in accordance with an embodiment of the invention.

Roadway condition monitoring system 10 is configured to monitor traffic of vehicles 14 along one or more monitored roadways 12. Typically, monitored roadways 12 that are monitored by roadway condition monitoring system 10 are located at a single site. For example, the site may include a mining site, a construction site, or another type of site. Monitored roadways 12 at a site may be interconnected, e.g., with each monitored roadway 12 intersecting or otherwise contiguous with at least one other monitored roadway 12 such that there is a contiguous path from a point along one monitored roadway 12 to any other point along any other monitored roadway 12 at the site.

In some cases, the course of a monitored roadway 12 may be determined by one or more boundary structures 13. For example, a boundary structure 13 may include a (naturally occurring or excavated) wall, cliff, or drop, a safety berm (e.g., as maintained by a maintenance crew at the site), a safety rail, by a structure (e.g., a temporary or permanent hut, trailer, or building, by power lines and support poles or towers, by lampposts or other illumination structures, or by other structures), by equipment that is operating alongside that monitored roadway 12, or other types of structure that prevents or impedes a vehicle 14 from straying laterally off of that monitored roadway 12.

In some cases, an obstacle 18 may be formed along a monitored roadway 12. For example, obstacle 18 may include part of a transported load that has fallen off of a vehicle 14, a vehicle 14 that has become disabled or abandoned, material (e.g., boulders, rocks, soil, trees, or other material) that has slid, fallen, or has been washed onto monitored roadway 12 from an elevated area that adjoins monitored roadway 12, equipment that is operating on monitored roadway 12, a vehicle 14 (e.g., carrying a large or wide load) that is travelling along monitored roadway 12 (e.g., more slowly than other vehicles 14), people that are walking along monitored roadway 12, animals that have strayed onto monitored roadway 12, or other types of objects that may obstruct or interfere with traffic of a vehicle 14 along monitored roadway 12. An obstacle 18 may include a pit, pothole, depression, puddle, crack, fracture, sinkhole, or other depression that may be formed by traffic of vehicles 14 along monitored roadway 12, mining or construction operations on, or adjacent to, monitored roadway 12, by weather or flooding conditions, or otherwise, and that may obstruct or interfere with traffic of a vehicle 14 along monitored roadway 12. In some cases, an obstacle 18 in the form of a crack or fracture may indicated that the ground on monitored roadway 12 is unstable or in danger of collapsing.

Typically, one or more monitored roadways 12 at the site may be temporary, e.g., unpaved and subject to changes as operations at the site progress. For example, excavation operations or dumping operations along a monitored roadway 12 may give rise to a change in the course of that monitored roadway 12. Roadway condition monitoring system 10 is configured to continually detect and map changes in the course of one or more monitored roadways 12. In some cases, one or more monitored roadways 12 may include permanent or established (e.g., paved) roads.

Vehicles 14 may include tractors, bulldozers, tractors, trucks (e.g., dump trucks or other transport vehicles), or other vehicles. Each vehicle 14 is provided with a vehicle unit 16 that is configured to communicate with system controller 20 of roadway condition monitoring system 10. Parameters that are sensed by the sensors of vehicle unit 16 may be communicated to system controller 20.

One or more components of system controller 20 may be located at a site where roadway condition monitoring system 10 operates, or may be located remotely from the site. In some cases, functionality of one or more components of system controller 20 may be provided by components of one or more vehicle units 16.

System controller 20 includes processor 22. Processor 22 may include a single processing unit, or a plurality of intercommunicating computers or processors that are configured to operate in accordance with programmed instructions.

Processor 22 is configured to communicate with data storage 24. Data storage 24 may include one or more volatile or nonvolatile, fixed or removable, memory or data storage devices. Data storage 24 may include one or more local or remote storage devices that are in communication with system controller 20. Data storage 24 may be utilized to store, for example, programmed instructions for operation of processor 22, data or parameters for use by processor 22 during operation, or results of operation of processor 22 (e.g., one or more databases relating to a nominal traffic pattern 11, a current traffic pattern 11′, a map of monitored roadway 12, or other databases).

System controller 20 includes wireless communications connection 26 to enable wireless communication between system controller 20 and vehicle units 16.

Processor 22 of system controller 20 may be configured to analyze sensed data that is communicated via wireless communications connection 26 to system controller 20 from one or more vehicle units 16. Thus, processor 22 may monitor the progress of each vehicle 14 that travels along monitored roadway 12. The communicated data may include data that indicates the values of one or more parameters that characterize travel of a vehicle 14 on a monitored roadway 12. For example, the parameters may include at least a speed of travel at each point on monitored roadway 12. Additional parameters may include a direction of travel, a steering angle, acceleration or deceleration, slope or tilt, application or brakes, shifting of gears, fuel consumption rate, or other parameters that characterize travel along monitored roadway 12.

Analysis of received data by processor 22 from single trips of a plurality of vehicles 14 that travel along a monitored roadway 12, from multiple trips by a single vehicle 14 along monitored roadway 12, or from multiple trips by each of a plurality of vehicles 14, may enable processor 22 to calculate a nominal traffic pattern. The nominal traffic pattern is represented schematically in FIG. 1 by nominal traffic pattern 11. Typically, monitored roadway 12 is divided into a plurality of roadway segments 15 (separated by segment boundaries 17). Each roadway segment 15 represents a section of monitored roadway 12. Nominal traffic pattern 11 is parameterized by one or more characteristics of traffic of vehicles 14 within each roadway segment 15. The characteristics typically include at least an expected speed of travel within a roadway segment 15. Other characteristics may include an expected direction of travel, expected accelerations and decelerations, expected steering angles, or other characteristics.

The division of monitored roadway 12 or nominal traffic pattern 11 into roadway segments 15 may be in accordance with one or more criteria. In some examples, each roadway segment 15 may be of a predetermined length. For example, the length of each roadway segment 15 may be determined by a preciseness of location of a vehicle 14, e.g., as limited by the resolution of a GNSS or other technique or sensor used to determine the location of a vehicle 14. In some cases, the length of a roadway segment 15 may be selected such that expected (or measured) characteristics of nominal traffic pattern 11 within each roadway segment 15 are approximately uniform (e.g., as determined by a variance, or similar statistical measure of deviation from an average value, of a parameter that characterizes traffic within a roadway segment 15). For example, where a monitored roadway 12 includes many or sharp curves, bumps or dips, or changes in surface conditions, e.g., as noted by sensors of vehicle units 16, a monitored roadway 12 may be divided into shorter roadway segments 15 than where a monitored roadway 12 is straight, flat, and with a uniform surface. In another example, analysis of nominal traffic pattern 11 itself may reveal roadway segments 15 in which deviations from average values are below a predetermined maximum.

In some cases, monitoring of vehicles 14 travelling along a monitored roadway 12 may reveal a roadway segment 15, such as roadway segment 15a, in which a current traffic pattern 11′ deviates from nominal traffic pattern 11. A current traffic pattern 11′ may be calculated from sensor data that is acquired during a single trip of a single vehicle 14 along roadway segment 15a, or during multiple trips by one or more vehicles 14 along roadway segment 15a.

In the example shown, the deviation of current traffic pattern 11′ from nominal traffic pattern 11 results from the presence of an obstacle 18 along roadway segment 15a on monitored roadway 12. In this case, processor 22 of system controller 20 may detect the deviation, and report the deviation via wireless communications connection 26 (or another, wired or wireless communications channel), to one or more recipients.

Recipients may include, for example, a manager of the site at which roadway condition monitoring system 10 operates, a maintenance crew, personnel responsible for directing traffic of vehicles 14 at the site, to operators of vehicles 14 (or operators of vehicles 14 along roadway segment 15a or monitored roadway 12), or another recipient.

In other examples, a deviation of current traffic pattern 11′ from nominal traffic pattern 11 may be the result of a defect in monitored roadway 12, inclement weather conditions, heavier traffic than usual, or another cause.

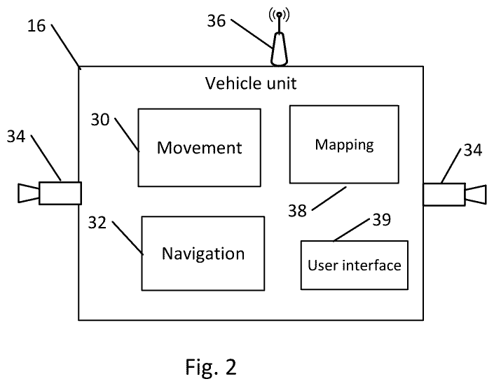

FIG. 2 is a schematic block diagram of an example of a vehicle unit of the roadway condition monitoring system illustrated in FIG. 1.

A vehicle unit 16 is mounted onto a vehicle 14. Each vehicle unit 16 includes a plurality of sensors that are configured to sense various characteristics of monitored roadway 12 or of travel of vehicle 14 along monitored roadway 12.

In some cases, vehicle unit 16 may include one or more movement sensors 30 that are configured to sense one or more parameters related to movement of vehicle 14 as it travels along monitored roadway 12. For example, movement sensors 30 may include one or more of a speedometer, odometer, accelerometer, steering angle sensor, IMU, brake sensor, or other types of sensor that may operate to characterize operation or movement of vehicle 14. Some or all of movement sensors 30 may be original equipment that is preinstalled in vehicle 14 prior to installation of vehicle unit 16. For example, vehicle unit 16 may access preinstalled movement sensors 30 via an onboard computer of vehicle 14, or may be otherwise connected to vehicle unit 16. Some or all of movement sensors 30 may be installed on vehicle 14 at the time of installation of vehicle unit 16.

Vehicle unit 16 may include one or more navigation sensors 32. Navigation sensors 32 may include one or more sensors or aids that enable determination of a position, orientation, direction of travel, or other parameters that characterize one or more of a current position, direction of travel, speed of travel, or other characteristic of travel of vehicle 14 on monitored roadway 12. For example, navigation sensors 32 may include one or more of a GNSS receiver, an IMU (which may function one or both of a movement sensor 30 and a navigation sensor 32), a gyroscope, a compass, a tilt sensor, or another sensor that may characterize travel of vehicle 14 in two or three dimensions.

Vehicle unit 16 may include mapping sensors 38 that are configured to assist in mapping a current environment of vehicle 14. For example, mapping sensors 38 may include one or more imaging devices 34 that may acquire data that may be processed to produce a two- or three-dimensional map of the surroundings of vehicle 14. Typically, either different imaging devices 34 are configured to acquire images of fields of view on different sides of vehicle 14, or a single imaging device 34 is operable to successively acquire images of different fields of view. For example, an imaging device 34 may include a video camera or a camera that acquires single frames. An imaging device 34 may include a stereo camera, a pair of single cameras, or other camera that is capable of acquiring three-dimensional imaging data that may be processed to yield three-dimensional data regarding imaged surfaces or objects. An imaging device 34 may be configured to acquire images in the visible spectral range, in the infrared spectral range, or in another spectral range. An imaging device 34 may be stationary or movable, e.g., capable of being panned, tilted, or both.

Mapping sensors 38 may include one or more other sensors (e.g., other than imaging devices 34) that may be operated to produce a three-dimensional map of the topography, e.g., of surfaces or objects, that surround vehicle 14. For example, mapping sensors 38 may include a scannable lidar or radar device that is capable of determining a distance to a nearest surface as a function of direction.

Vehicle unit 16 includes wireless communications connection 36 to enable wireless communication between vehicle unit 16 and system controller 20. For example, vehicle unit 16 may be configured to transmit data that was acquired via movement sensors 30, navigation sensors 32, mapping sensors 38, or otherwise (e.g., input by an operator of vehicle 14) via wireless communications connection 36 to wireless communications connection 26 of system controller 20. Processor 22 of system controller 20 may analyze data that is received from one or more vehicle units 16 to calculate a nominal traffic pattern 11, to detect a current traffic pattern 11′ that deviates from nominal traffic pattern 11, to detect or determine a nature of an obstacle 18, or to otherwise monitor a condition of one or more monitored roadways 12.

Vehicle unit 16 may include a user interface 39. User interface 39 may include one or more visual output devices (e.g., display screens, indicator lights, or other visual output devices), one or more audible output devices (e.g., speakers, alarms, or other devices) for communicating audibly verbal or nonverbal information, e.g., to an operator of vehicle 14. User interface 39 may include one or more input devices for inputting data (e.g., an identification of an obstacle 18, or other input data).

In some cases, vehicle unit 16 may receive instructions, commands, alerts, or other data via wireless communications connection 36 from system controller 20. For example, system controller 20 may request additional data from vehicle unit 16, may send an alert regarding an obstacle 18 or other deviation of a current traffic pattern 11′ from nominal traffic pattern 11, or may otherwise communicate with vehicle unit 16. In some cases, a received alert or other communication may be presented to an operator of vehicle 14 via user interface 39.

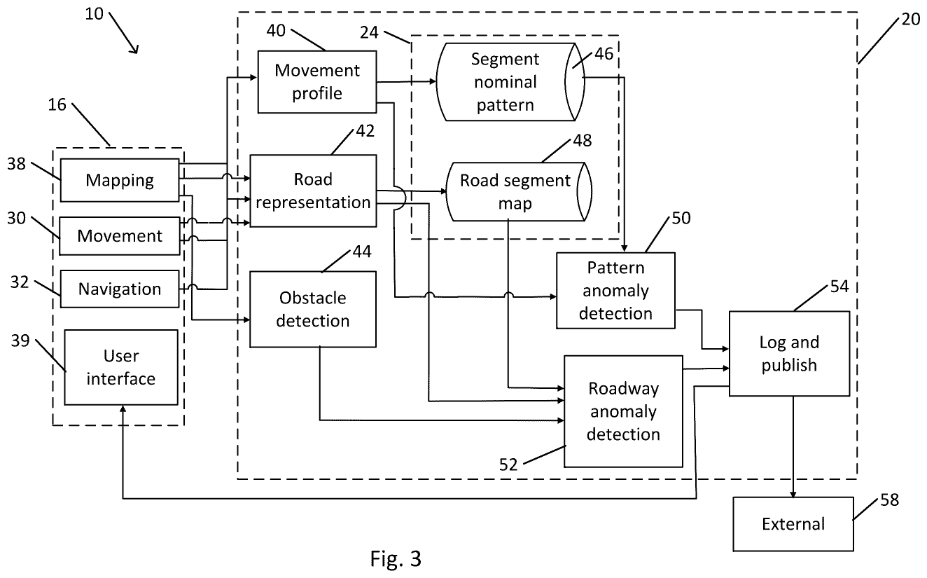

FIG. 3 is a schematic block diagram illustration of an example of operation of the roadway condition monitoring system illustrated in FIG. 1.

A movement profile module 40 executing on processor 22 of system controller 20 may receive data from one or more of mapping sensors 38, movement sensors 30, and navigation sensors 32. Movement profile module 40 may analyze the received data and calculate a nominal traffic pattern 11 for each roadway segment 15 along one or more monitored roadways 12. For example, movement profile module 40 may be configured to apply a filter (e.g., an average, weighted average, low-pass filter, or other relevant statistical analysis technique) to sensor data from multiple travels of one or more vehicles 14 along each roadway segment 15 of monitored roadway 12.

Typically, a nominal traffic pattern 11 includes a nominal speed profile and path of one or more types of vehicle 14 travelling along each roadway segment 15 of one or more monitored roadways. The form of the speed profile and path may depend on the length of roadway segment 15, the uniformity of roadway segment 15, or other factors. For example, in some cases (e.g., in a long or varying roadway segment 15) a speed profile may include a speed as a function of position within roadway segment 15. In other cases (e.g., in a short of uniform roadway segment 15), a speed profile may include a single representative (e.g., average) speed within roadway segment 15. Similarly, a path may include a direction of travel at each position within roadway segment 15, or may include a single direction of travel. In some cases, a nominal traffic pattern 11 may include additional parameters that characterize travel of a vehicle 14 on a roadway segment 15 (e.g., a pattern of acceleration, tilt or slope, or other parameters). The calculated nominal traffic patterns 11 may be stored in segment nominal pattern database 46 on data storage 24 of system controller 20.

Further analysis of the received data by movement profile module 40 may continue to calculate current traffic patterns. Calculated current traffic patterns 11′ may be input to pattern anomaly detection module 50. Pattern anomaly detection module 50 is configured to compare a current traffic pattern 11′ as calculated by movement profile module 40 for a roadway segment 15 with a nominal traffic pattern 11 for that roadway segment 15 that is stored in segment nominal pattern database 46. For example, an irregularity or anomaly may be detected by one or more of applying a VSLSM technique, utilizing GNSS or IMU data, or otherwise to compare a sensed current traffic pattern 11′ with a nominal traffic pattern 11 for a roadway segment 15. For example, an anomaly may be characterized by a difference in driving time or speed profile between current traffic pattern 11′ and nominal traffic pattern 11. As another example, an anomaly may be characterized by avoidance maneuvers, accelerations, decelerations, or other nonstandard driving patterns that are detected in current traffic pattern 11′.

In some cases, pattern anomaly detection module 50 may be configured to modify a nominal traffic pattern 11 that is stored in segment nominal pattern database 46, e.g., in accordance with predetermined criteria or application of a suitable filter (e.g., a sliding average or other technique). For example, pattern anomaly detection module 50 may be configured to modify a stored nominal traffic pattern 11 if an anomaly persists for a predetermined period of time (e.g., after notification to a crew that is tasked to correct a detected anomaly), or where analysis of the anomaly indicates that the anomaly is likely to persist for a predetermined period of time.

When pattern anomaly detection module 50 detects an anomaly in which a current traffic pattern 11′ for a roadway segment 15 deviates (e.g., as defined by predetermined criteria) from nominal traffic pattern 11, the anomaly may be input to log and publisher module 54. For example, log and publisher module 54 may save the detected deviation in a database of anomalies, e.g., on data storage 24 of system controller 20.

In some cases, log and publisher module 54 may issue a notification regarding any detected anomalies. For example, log and publisher module 54 may transmit to one or more recipients a notification that includes information regarding a detected anomaly. For example, an alert related to a detected anomaly may be transmitted to user interface 39 of one or more vehicle units 16. In some cases, an alert may be transmitted only to vehicle units 16 of vehicles 14 that are travelling on a monitored roadway 12 along which the anomaly was detected, that is travelling in or near a roadway segment 15 in which the anomaly was detected, or to all vehicle units 16 at a site. Thus, an operator of a vehicle 14 may receive alerts or information related to conditions of a monitored roadway 12 and obstacles 18 in real time.

In some cases, log and publisher module 54 may transmit data regarding an anomaly to one or more external destinations 58. For example, an external destination 58 may include a site manager, a maintenance crew, or another recipient. In some cases, an external destination 58 may include a vehicle guidance system that is configured to guide, or autonomously operate, one or more vehicles 14. For example, the vehicle guidance system may utilized the transmitted data to plan an alternate route for one or more vehicles 14.

A road representation module 42 executing on processor 22 of system controller 20 may receive data from one or more of mapping sensors 38, movement sensors 30, and navigation sensors 32 (e.g., GNSS data from navigation sensors 32). Road representation module 42 may analyze the received data and generate (e.g., create or modify) a three-dimensional representation of one or more roadway segments 15 of one or more monitored roadways 12.

In some cases, data from mapping sensors 38 may be insufficient for generation of three-dimensional mapping data. For example, an imaging device 34, a lidar device, or other device may have a limited field of view or scanning range, or may otherwise be unsuitable for collecting sufficient data to build a three-dimensional map. In this case, road representation module 42 may be configured to combine data regarding movement of vehicle 14 (e.g., from movement sensors 30 (e.g., IMU, speedometer, odometer, or other sensor), navigation sensors 32 (e.g., GNSS data), or both) with data from mapping sensors 38 to generate the three-dimensional map. For example, road representation module 42 may apply one or more three-dimensional reconstruction techniques, such as visual simultaneous localization and mapping (VSLAM) techniques, structure from motion (SFM) techniques, or other techniques to combine data from mapping sensors 38 with concurrent position or motion of vehicle 14 to generate a three-dimensional map.

The three-dimensional representation in the form of a three-dimensional map may be in stored in road segment map database 48 on data storage 24 of system controller 20.

An obstacle detection module 44 may execute on processor 22 of system controller 20. Obstacle detection module 44 may be configured to receive data from mapping sensors 38, e.g., one or more imaging devices 34, and to analyze the received data. Analysis of the receive data, e.g., by application of one or more image processing or image analysis techniques may detect a surface or object whose location, orientation, size, shape, or other property is indicative of the presence of an obstacle 18. For example, obstacle detection module 44 may apply an algorithm for two- or three-dimensional analysis of imaged surfaces. An algorithm for detecting and identifying or classifying obstacles 18 may be based on one or more machine learning techniques (e.g., deep learning or other methods).

Obstacle detection module 44 may be configured to detect or identify other issues that affect safety or quality of a monitored roadway 12. For example, obstacle detection module 44 may measure a width of monitored roadway 12, dimensions of a berm or safety barrier along monitored roadway 12, or other issues that affect traffic of vehicles 14 along monitored roadway 12.

Roadway anomaly detection module 52 executing on processor 22 of system controller 20 may receive data from one or both of road representation module 42 and obstacle detection module 44. Roadway anomaly detection module 52 may analyze the received data and utilize one or more three-dimensional maps that are stored in road segment map database 48 to determine a location of a detected obstacle 18 (or other anomaly or deviation between current data received from road representation module 42 and a three-dimensional map stored in road segment map database 48), e.g., relative to a map of monitored roadway 12 or of roadway segment 15.

In some cases, roadway anomaly detection module 52 may be configured to modify a three-dimensional map that is stored in road segment map database 48. For example, analysis of an anomaly may indicate a persistent change in the topography of a monitored roadway 12. In that case, roadway anomaly detection module 52 may operate in accordance with predetermined criteria (e.g., related to the nature of the anomaly or the time that the anomaly persists, e.g., by application of an appropriate sliding average or other filter) to modify the stored three-dimensional map.

The location of an anomaly that is detected by operation of roadway anomaly detection module 52, and the type or classification of the anomaly, if known, may be input into log and publisher module 54, e.g., for storage in a database. The information that was input into log and publisher module 54 may be sent as an alert or update to user interface 39, to an external destination 58, or both. For example, an external destination 58 may include an obstacle removal crew, a berm maintenance crew, or another relevant recipient.

In some cases, roadway anomaly detection module 52 may transmit an acquired image of a portion of a roadway segment 15 that includes an obstacle 18 or another anomaly. The anomaly may be marked on the transmitted image, or the image may be accompanied by an image that was acquired prior to formation of the anomaly.

One or both of anomaly detection module 50 and roadway anomaly detection module 52 may be configured to apply anomaly detection algorithms or criteria that are based on machine learning or deep learning algorithms. For example, anomaly detection module 50 or roadway anomaly detection module 52, or another module executing on processor 22 (or on another processor that is associated with roadway condition monitoring system 10) may learn to recognize anomalies by using independently identified examples of sensor data. For example, the learning process may be based on data such as one or more of three-dimensional maps, images, video images, vehicle positions, vehicle speeds, speed profiles, trajectory profiles, recorded behavior of a driver of a vehicle 14, recorded performance of a vehicle 14, environmental data (e.g., weather conditions), or other data related to travel of a vehicle 14 on a roadway segment 15. The results of the learning process may be incorporated into operation of one or more of anomaly detection module 50, roadway anomaly detection module 52, obstacle detection module 44, or other operation of processor 22.

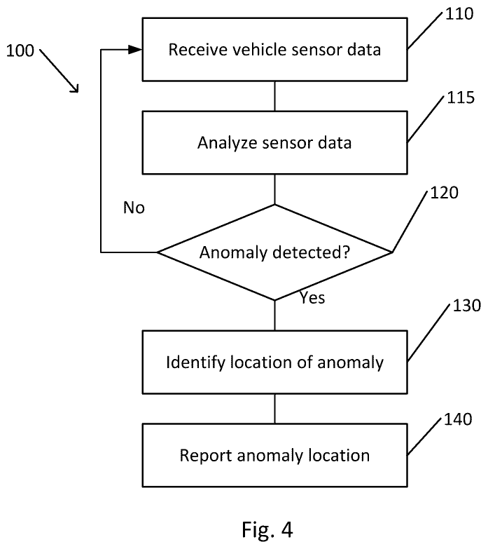

FIG. 4 is a flow chart depicting a method of operation of the roadway condition monitoring system illustrated in FIG. 1.

Execution of roadway monitoring method 100 is intended to monitor in real time the condition of a monitored roadway 12 at a site, and to detect in a timely manner any defects along the roadway (e.g., in order to minimize any adverse effect of the defects on traffic or other operations along monitored roadway 12).

Operations of roadway monitoring method 100 may be executed by a processor 22 of a system controller 20 of roadway condition monitoring system 10. Roadway monitoring method 100 may be executed continuously during operation of roadway condition monitoring system 10.

It should be understood with respect to any flowchart referenced herein that the illustrated division of the method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Processor 22 of system controller 20 receives sensor data from one or more vehicle units 16 of one or more vehicles 14 (block 110). For example, the data may be received from one or more of movement sensors 30, navigation sensors 32, imaging devices 34 or other mapping sensors 38, or other types of sensors.

The received sensor data may be analyzed by one or more modules operating on processor 22 (block 115). For example, the sensor data may be analyzed by one or more of a movement profile module 40, a road representation module 42, or an obstacle detection module 44 operating on processor 22. The analysis may yield calculation of a nominal roadway condition, such as a nominal traffic pattern 11, a current traffic pattern 11′, a map of a roadway segment 15, or another characteristic of one or more roadway segments 15, or traffic of vehicles 14 along roadway segments 15. Results of the analysis may be stored on data storage 24 of system controller 20. For example, a nominal traffic pattern 11 may be stored in segment nominal pattern database 46, and a three-dimensional map may be stored in road segment map database 48.

In some cases, analysis of the data (e.g., comparing results of analysis of currently received data with stored analysis results, or with other stored data) may detect an anomaly between a current roadway condition and a nominal roadway condition, e.g., related to patterns of traffic of vehicles 14 along a roadway segment 15, or to a mapped topography of roadway segment 15 (block 120).

For example, the analysis may determine that a current traffic pattern 11′ (e.g., resulting from analysis of sensor data by movement profile module 40 and pattern anomaly detection module 50) deviates from a previously determined nominal traffic pattern 11 along a roadway segment 15 (e.g., manifested by slowing or turning of vehicles 14 within roadway segment 15, or otherwise). In another example, mapping of the surroundings of a vehicle 14 (e.g., resulting of analysis of sensor data by one or more of road representation module 42, obstacle detection module 44, and roadway anomaly detection module 52) may determine that the topography of monitored roadway 12 within a roadway segment 15 has been modified, or that otherwise deviates from an expected topography (e.g., narrowing of monitored roadway 12, lack or degradation of a safety berm or barrier, or otherwise).

If no anomaly is detected, receiving of sensor data may continue (return to block 110).

If an anomaly is detected, a location of the anomaly may be identified (block 130). For example, execution of pattern anomaly detection module 50, roadway anomaly detection module 52, or both may identify a location of the detected anomaly, e.g., relative to a three-dimensional map that is stored in road segment map database 48.

In some cases, execution of pattern anomaly detection module 50, roadway anomaly detection module 52, or both may attempt to identify a cause or nature of the detected anomaly. For example, image data that is acquired by one or more imaging devices 34, or other mapping sensors 38, may be analyzed using one or more image identification techniques to identify an obstacle 18 or other defect of monitored roadway 12. For example, anomaly identification algorithms may be developed using machine learning techniques, e.g., for a particular monitored roadway 12 or site, or for a plurality of sites. For example, an algorithm may be developed using a training method that includes analysis by a processor of images of various types of independently identified (e.g., by a human operator) obstacles 18 or other types of anomalies.

The location of the anomaly may be reported to one or more relevant recipients or destinations (block 140). When the cause of the anomaly has been identified, the identified cause may also be reported. In some cases, recipients may be selected in accordance with the identified cause of the anomaly. For example, the anomaly may be reported to a maintenance team that is tasked with maintenance and repair tasks that would result in removal of the anomaly. Typical recipients may include a user interface 39 of one of more vehicle units 16, an external destination 58 (e.g., a maintenance or supervisory crew), or other relevant recipients.

Different embodiments are disclosed herein. Features of certain embodiments may be combined with features of other embodiments; thus, certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A roadway condition monitoring system comprising:
one or more sensors configured to be mounted on one or more vehicles that operate on a roadway; and
a processor that is configured to:
receive sensed data that is acquired by said one or more sensors, the sensed data comprising at least a value of each of one or more parameters that characterize a roadway condition that includes one or both of a pattern of travel of the one or more vehicles along the roadway and a mapping of the roadway;
calculate a current roadway condition from the sensed data that is received during a current trip of the one or more vehicles on a segment of the roadway;
compare the current roadway condition with a nominal roadway condition that characterizes one or both of traffic of the one or more vehicles in the segment of the roadway and mapping of the segment, the calculation of the nominal roadway condition obtained utilizing the sensed data that is received from the one or more sensors during a plurality of trips of the one or more vehicles on the segment;
detect an anomaly in which the current roadway condition deviates from the nominal roadway condition;
identify, from the sensed data, the location of the anomaly;
identify the cause of the anomaly;
report the detected anomaly and the cause of the anomaly by issuing a notification to an external destination.

2. The system of claim 1, wherein the external destination comprises one or more recipients that include at least one of: a manager of a site at which the roadway condition monitoring system operates, a maintenance crew, and personnel responsible for directing traffic of vehicles at the site.

3. The system of claim 1, wherein the processor is further configured to calculate the nominal roadway condition.

4. The system of claim 1, wherein the sensed value of a parameter of the one or more parameters is selected from a group of parameters consisting of: a speed of travel, a direction of travel, a steering angle, an acceleration, a deceleration, a location of the vehicle and a distance travelled.

5. The system of claim 1, wherein a sensor of the one or more sensors is selected from a group of sensors consisting of: a speedometer, an inertial measurement unit (IMU), a global navigation satellite system (GNSS) receiver, an odometer and a steering angle sensor.

6. The system of claim 1, wherein the one or more sensors comprise a mapping sensor.

7. The system of claim 6, wherein the mapping sensor comprises a sensor selected from a group of sensors consisting of: an imaging device, lidar and radar.

8. The system of claim 6, wherein the processor is configured to generate a map of the roadway by applying a three-dimensional reconstruction technique to data received from the mapping sensor and from at least one other sensor of the one or more sensors.

9. The system of claim 8, wherein the three-dimensional reconstruction technique comprises a visual simultaneous localization and mapping (VSLAM) technique or a structure from motion (SFM) technique.

11. The system of claim 1, wherein the processor is further configured to transmit an image of the identified obstacle or defect.

12. The system of claim 1, wherein the processor is configured determine a location of the identified obstacle or defect-relative to the mapping of the roadway.

13. The system of claim 12, wherein the processor is configured to include in the notification the location of the identified obstacle or defect.

14. A method for monitoring a condition of a roadway, the method comprising:
mounting one or more sensors on one or more vehicles that operate on a roadway;
using a processor:
receiving sensed data that is acquired by said one or more sensors, the sensed data comprising at least a value of each of one or more parameters that characterize a roadway condition that includes one or both of a pattern of travel of the one or more vehicles along the roadway and a mapping of the roadway;
calculating a current roadway condition from the sensed data that is received during a current trip of the one or more vehicles on a segment of the roadway;
comparing the current roadway condition with a nominal roadway condition that characterizes one or both of traffic of the one or more vehicles in the segment of the roadway and mapping of the segment, the nominal roadway condition utilizing the sensed data that is received from the one or more sensors during a plurality of trips of the one or more vehicles on the segment;
detecting an anomaly which the current roadway condition deviates from the nominal roadway condition,
identifying, from the sensed data, an obstacle or defect on the segment of the roadway relating to the anomaly; and
reporting the detected anomaly by issuing a notification to an external destination.

15. The method of claim 14, wherein the external destination comprises one or more recipients that include at least one of: a manager of a site at which the roadway condition monitoring system operates, a maintenance crew and personnel responsible for directing traffic of vehicles at the site.

16. The method of claim 14, further comprising generating a map of the roadway.

17. The method of claim 16, wherein generating the map comprises applying a three-dimensional reconstruction technique to data received from a mapping sensor and from at least one other sensor of the one or more sensors.

18. The method of claim 17, wherein the three-dimensional reconstruction technique comprises a VSLAM technique or an SFM technique.

19. The method of claim 14, further comprising determining a location of the identified obstacle or defect.
